(19) United States
(12) Patent Application Publication
(10) Pub. No.: US 2025/0266641 A1
(43) Pub. Date: Aug. 21, 2025

(54) POWER SOCKET ASSEMBLY AND METHOD OF INSTALLING SAID ASSEMBLY

(71) Applicant: Shiver nv, Veurne (BE)

(72) Inventor: Thibault RENSON, Veurne (BE)

(21) Appl. No.: 18/582,585

(22) Filed: Feb. 20, 2024

(51) Int. Cl. H01R 13/52; H01R 13/506; H01R 13/74; H01R 24/78; H01R 103/00

(52) U.S. Cl. CPC H01R 13/5213; H01R 13/506; H01R 13/748; H01R 24/78; H01R 2103/00

(57) ABSTRACT

A removable power socket assembly is made advantageously simple to install and remove by means of a press-fit or snap-fit cover plate and a power socket comprising a void accessible through an opening of said cover plate. Said assembly advantageously dispenses with the use of visible fasteners to securely attach the cover plate to the power socket while still permitting effortless removal of said cover plate for maintenance.

### FIELD OF THE INVENTION

The present invention relates to a power socket assembly for appliance connections that are disposed for example on a wall of a building, such as housing and offices, or in a piece of furniture.

### BACKGROUND

Power socket assemblies such as those suitable for connection of domestic appliances are commonly mounted to walls of a building. Such power socket assemblies are an intermediary between electrical cables reaching from power mains or the like, and a plug of an appliance by way of a plurality of electrical contacts. Further to such power socket assembly, a front plate is provided which covers the actual power socket and shields electrical contacts in the power socket. Such cover plate is usually attached to the power socket with the use of screws. These screws require additional space around the power socket, increasing the size of the power socket assembly. The screws are esthetically unpleasing. Attaching the cover plate is cumbersome because the cover plate must be aligned with the power socket and simultaneously hold in position, while placing and fastening the screws. Removing the cover plate is as cumbersome and often results in losing one of the screws.

The invention thereto aims to provide, relative to the state of the art, an improved power socket assembly which dispenses with the known complexities of installation, while providing for a more convenient integration of said assembly in its surrounding construction and for easier maintenance of said assembly.

### SUMMARY OF THE INVENTION

The present invention and embodiments thereof serve to provide a solution to one or more of above-mentioned disadvantages. To this end, the present invention relates to a power socket assembly.

Said power socket assembly is made advantageously simple to install and remove by comprising a press-fit or a snap-fit cover plate and a power socket comprising a void accessible through an opening of said cover plate. Said assembly advantageously dispenses with the use of visible fasteners to securely attach the cover plate to the socket while still permitting effortless removal of said cover plate for maintenance.

The preferred embodiments of the device are shown in the embodiments described herein.

A specific preferred embodiment relates to a power socket assembly according to the embodiments described herein.

In said embodiment, the complete assembly is made flush with the surface in which into which it is mounted, thus greatly improving installation possibilities for the power socket assembly.

In a second aspect, the present invention relates to a method. More particular, the method as described herein provides steps for both the assembly and the removal of the cover plate of the power socket assembly.

In a third aspect the present invention relates to a kit. The kit as described herein provides all elements necessary for fast and simple installation of the power socket assembly according to the present invention.

### DESCRIPTION OF FIGURES

The following description of the figures of specific embodiments of the invention is merely exemplary in nature and is not intended to limit the present teachings, their application or uses. Throughout the drawings, corresponding reference numerals indicate like or corresponding parts and features.

FIG. 1 shows a power socket being inserted into a wall.

FIG. 2 shows the step of installing the cover plate onto the power socket.

FIG. 3 shows a lateral view of the step of installing the cover plate onto the power socket.

FIG. 4 shows a step of removing the cover plate using the ground pin of a power plug of an appliance.

FIG. 5 shows the assembled power socket assembly.

FIG. 6 shows the cover plate after application of a prying motion using the ground pin of the plug of an appliance.

FIG. 7 shows a power socket of type I before installation of the cover plate.

FIG. 8 shows a power socket of type I after installation of the cover plate.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In this context, the term surface is to be understood as a wall, ceiling, floor, beam, channel, piece of furniture or any other construction and/or any other structure suitable to receive a power outlet.

In a first aspect, the invention provides a power socket assembly comprising:
a power socket comprising use side electrical contacts; and
a cover plate for covering the said power socket, the cover plate having openings to permit access to the electrical contacts of the power socket;

In a preferred embodiment, the cover plate is press-fit or snap-fit onto said power socket, which power socket comprises a void behind the cover plate, said void is located adjacently to a passage in the power socket leading to an electrical contact and is accessible for a tip of a tool inserted through an opening to the electrical contact said void. Press-fit and snap-fit assemblies are advantageously fast, simple and economical to carry out. The challenge with snap-fit assemblies is that the fastening elements, in this case snap fitting hooks, are difficult to impossible to access after assembling, which precludes non-destructive disassembly, for example for maintenance and/or repair. A similar disadvantage exists with press-fit assemblies. The present invention overcomes this problem by providing said void behind the assembled cover plate, which void is advantageously reachable via one of the openings of the cover plate. In this way, one is able to access a surface of the cover plate which surface is substantially opposite to the assembly direction of said cover plate, and thus gain sufficient purchase on the cover plate to non-destructively pull and/or pry it from the power socket. By preference, said cover plate is made of a non-conductive material or combination thereof, such as rubber most preferably plastic.

In an embodiment, said void is reachable via a ground opening of the power socket assembly. In this way, the risks associated with possible contact with electrically charged/active elements is advantageously minimized. Ground pins, and their openings are typically located off-center in most types of power outlets as is the case with the power socket assembly according to the present invention. By making the void accessible through the ground opening of the power socket assembly, one has substantially more mechanical advantage to unhook the cover plate than if said void was located closer to the center of the cover plate.

In an embodiment, said void comprises a vertical wall, preferably substantially, parallel to the cover plate and configured to shield the void from electrical contacts, said wall being located at a side of the void opposite toe the cover plate. Power sockets, due to their function, comprise a substantial number of electrical connections, some of which are active and which may be found in alignment even with the ground opening of the power socket assembly. In order to minimize the risk that a tool reaches too far into the power socket body and potentially cause fire and/or injury, the side of the void opposite to the cover plate is provided with a wall which advantageously limits the distance a tool can be inserted into the socket assembly. This is wall is additionally beneficial for prying the cover plate out. The wall can be used as a support for a tool.

In an embodiment, said void further comprises a lip extending from said wall towards the cover plate, said lip being located between said void and the adjacent electrical contact. Said lip further reduces the risk of any tool contacting any potentially electrically active element of the power socket when said tool reaches into the void. In order to further reduce said risk, the void is wider than the opening. In this way, one can laterally tilt the tool used to disassemble the cover plate from the socket, and further distance the tip of said tool from any electrical contact. The lip is additionally beneficial for prying the cover plate out. The lip avoids the tip of said tool slipping on said wall. By preference, said lip extends towards the cover plate about a third of the distance between said wall and the back of the cover plate.

In an embodiment, the power socket is a type B socket according to the IEC 60083:2015 standard. A type B socket has a large ground opening, suited for reaching into a void adjacent to a ground contact.

In an embodiment, the power socket is a type G socket according to the IEC 60083:2015 standard. A type G socket has a large ground opening, suited for reaching into a void adjacent to a ground contact.

In an embodiment, the power socket is a type I power socket according to the AS/NZS 3112:2017 standard.

In an embodiment, the power socket assembly is flush mounted in a surface. In this way, not only are the aesthetics of the power socket assembly improved, but more importantly, also the flush integration of the power socket assembly in the surrounding surface makes said power socket assembly immune to lateral impacts.

In an embodiment, said cover plate completely covers the use side of the assembly after mounting. The use side is the side that is available to a user. This is the side of the cover plate. This embodiment further enhances the aesthetics and function of the power socket assembly. By completely covering the use side of the power socket assembly, the cover plate prevents ingress of debris while hiding all fasteners and traces thereof.

In an embodiment, the cover plate comprises at least two snap-fitting hooks located opposite to each other relative to a center of said cover plate, at least one of said hooks being next to said void. By preference, inserting a tool inside the void already causes said at least one snap-fitting hook next to the said void to start to unhook. More preferably, said at least one snap-fitting hook next to the said void comprises a second bevel or fillet on the side of the hook facing the use side of the power socket assembly. Most preferably, the cover plate comprises a single hook next to the void. In this way, said hook is easier to unhook while still offering sufficient resistance to unhooking during normal use of the power socket assembly.

A second aspect of the present invention provides a method for installing and removing a cover plate of a socket assembly, the method comprising the steps of:
installing a power socket comprising use side electrical contacts onto a surface; and
installing said cover plate comprising opening for accessing said electrical contacts onto said power socket.

In a preferred embodiment the front cover plate is press-fit or snap-fit to the power socket, said power socket comprising a void adjacently extending from a passage in the power socket leading to an electrical contact, said void being located behind the cover plate and being accessible via an opening in the cover plate to the electrical contact adjacent to said void, the cover plate being removed by inserting a tip of a tool into said void and exerting force on the cover plate, said force having a substantially outwards direction towards a use side of the socket assembly. Preferably said void is located adjacent to the ground electrical contacts, thus reducing the risk of contact with any potentially electrically active element of the socket.

In an embodiment, the cover plate is removed by inserting the ground pin of a power plug into said void, and prying the cover plate out. Ground pins, being sized and shaped to fit the access opening to the ground electrical contacts are ideally suited to be used as a disassembly tool, preferably by applying a prying motion. In this way, one can disassemble the cover plate without any special tool and by using a readily available object. More advantageous still, an appliance plug is equipped with a grasping point made of non-conductive material. Prying is beneficial because it will not damage the use side of the cover plate.

In an embodiment, the cover plate is installed by inserting a first snap-fitting hook onto a complimentary recess on the power socket, the first hook being located next to said void and by subsequently inserting at least a second snap-fitting hook located opposite to said first hook. In this way, leverage on said last hook is advantageously high, thus facilitating hooking of said last hook.

In this context, opposite locations on the cover plate are to be understood as locations approximately symmetric to each other about a virtual plane intersecting an approximately central portion of the cover plate, said virtual plane being substantially perpendicular to the use side face of the cover plate. In this context, approximately symmetrical or approximate symmetry is to be understood as being within 15 mm of absolute symmetry about a plane.

In an embodiment, the cover plate is removed by first unhooking said first snap-fitting hook next to said void, and any further hooks afterwards. This permits taking advantage of the much higher leverage on the said first hook, making removal of the cover plate much easier.

In an embodiment, the cover plate is removed by inserting a hook into said void and by pulling with said hook. In this way, force is applied to the cover plate in a substantially outwards direction and normal to the use side surface of the cover plate, thus greatly reducing the risk contacting any electrically active element of the power socket. A hook is beneficial because it will not damage the use side of the cover plate.

A third aspect of the invention relates to a kit for mounting a socket assembly, the kit comprising:
a power socket having a use side with electrical contacts; and
a cover plate, the cover plate having openings to permit access to said electrical contacts of the power socket;

The cover plate is configured to be press-fit or snap-fit to said power socket, said power socket further comprising a void adjacently extending from a passage in the power socket leading to one of the electrical contacts. The kit as described herein provides an all elements necessary for fast and simple installation of the power socket assembly according to the present invention.

In a further embodiment, said kit comprises a disassembly tool made of non-conductive material, said tool being, by preference a rod or hook, most preferably a combination of both.

### DESCRIPTION OF FIGURES

With as a goal illustrating better the properties of the invention the following presents, as an example and limiting in no way other potential applications, a description of a number of preferred embodiments of the power socket assembly, wherein:

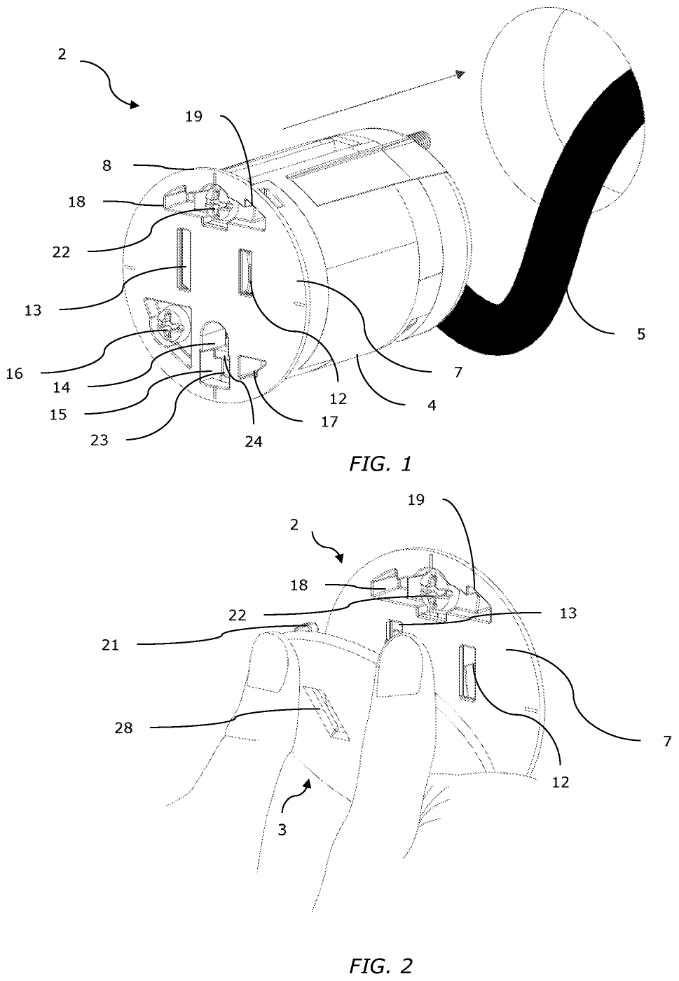

FIG. 1 shows a power socket (2) being inserted into a wall. Said power socket (2) is shown comprising a substantially cylindrical body (4) connected to an electrical cable (5) extending from a hole in said wall (6), which hole is substantially complementary to the perimeter of the body (4) of the power socket (2). The shown power socket (2) is a type B according to IEC 60083:2015 standard. A use side of the power socket (2) is shown comprising a flange (8) around the use side face (7) of the power socket (2). Said face (7) is shown comprising three electrical contacts disposed inside three electrical contact openings (12, 13, 14). The substantially horizontally centered opening (14) located on the lower portion of the use side face (7) of the power socket (2) comprises ground electrical contacts, said opening (14) adjacently extending towards the nearest perimeter of the power socket (2) to form a void (15). A first fastener recess (16) is shown located next to said void (15) on a first lateral side, a first recess (17) for a first snap-fitting hook (25) is shown provided next to the void (15) on a second lateral side opposite to said first lateral side. A third and second recesses (19, 18), each for receiving a second and third snap-fitting hook (20, 21), are shown provided on an upper portion of the use side face (7) of the power socket (2). A second fastener recess (22) is also shown interposed between the latter two recesses (18, 19) for receiving a snap-fitting hook. The void (15) is shown comprising a wall (23) and a lip (24) extending from said wall (23) towards the use direction about a third of the distance between said (23) wall and the use side face (7) of the power socket (2).

FIG. 2 shows the step of installing the cover plate (3) onto the power socket (2). The power socket (2) is fastened by tightening the screws in the first fastener recess (16) and the second fastener recess (22). The figure shows the cover plate (3) in a tilted position, and with the first snap-fitting hook (25 not shown) already engaging the first recess for the first snap-fitting hook (17). The installation of the power socket assembly (1) is completed by aligning the tip of the second and third snap-fitting hooks (20 not shown, 21) with their corresponding recesses (18, 19). Subsequently, enough pressure is applied against the face of the cover plate (3) to deflect and snap said second and third snap-fitting hooks (20 not shown, 21) into said recesses (18, 19).

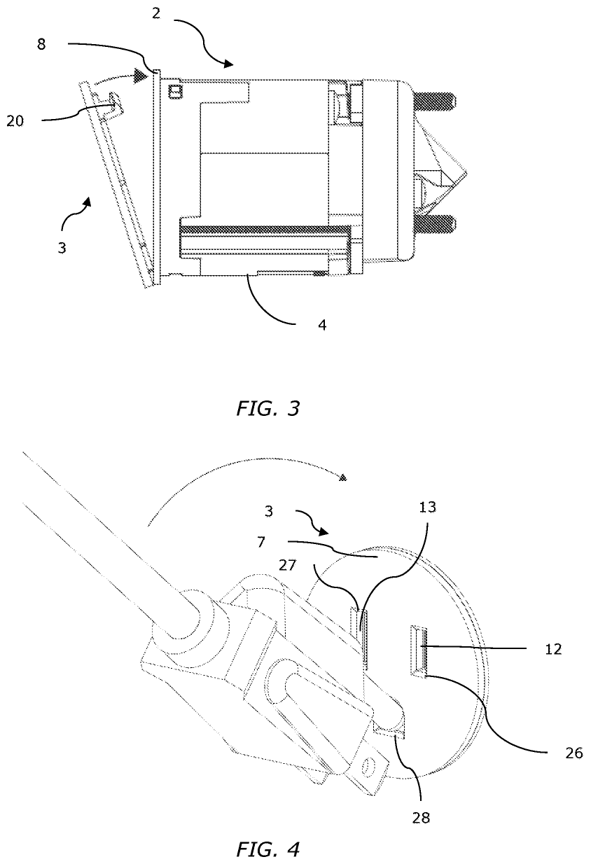

FIG. 3 shows a lateral view of the step of installing the cover plate (3) onto the socket (2). The figure shows the next stage of the said step relative to FIG. 2. The installation of the socket assembly (1) is completed by aligning the tip of the second and third snap-fitting hooks (20 not shown, 21) with their corresponding recesses (18 not shown, 19 not shown). Subsequently, enough pressure is applied against the face of the cover plate (3) to deflect and snap said second and third snap-fitting hooks (20 not shown, 21) into said recesses (18 not shown, 19 not shown).

FIG. 4 shows a step of removing the cover plate (3) using the ground pin of a power plug of an appliance. Said ground pin is shown introduced into the ground electrical contact opening of the cover plate (28) and reaching the void (15) behind the cover plate (3). At this stage, a prying motion cause by moving said plug towards the power socket (2) will unhook the first snap-fitting hook (25 not shown) as shown in FIG. 6.

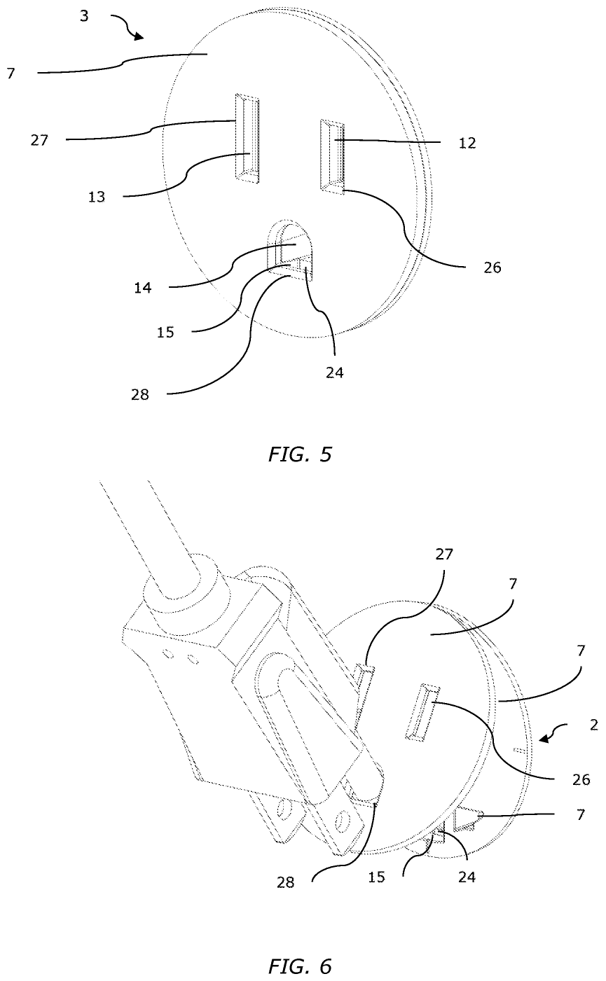

FIG. 5 shows the assembled socket assembly (1). The figure shows the electrical contact opening of the cover plate (26), the electrical contact opening of the cover plate (27) and the ground electrical contact opening of the cover plate (28). The void (7) and the lip (24) are visible on the bottom of the ground electrical contact opening of the cover plate (28).

FIG. 6 shows the cover plate (3) after application of a prying motion using the ground pin of the plug of an appliance. Said prying motion being caused by moving said plug towards the power socket (2) will unhook the first snap-fitting hook (25 not shown).

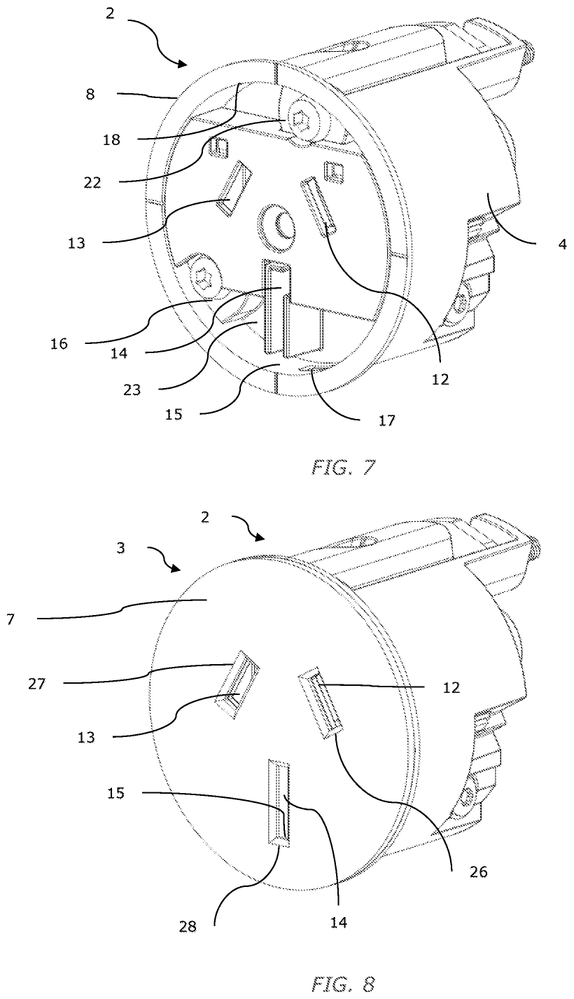

FIG. 7 shows a power socket (2) of type I before installation of the cover plate (3). The power socket (2) has a similar construction as the power socket (2) in FIGS. 1 to 6. A first important difference is that the present socket (2) is of type I according to AS/NZS 3112:2017 standard. Another important difference lies in the number and location of the snap-fitting hooks (20, 25), which in the present power socket (2) are two hooks (20, 25), each configured to engage a recess (17, 18) on the outer wall of the body (4) of the power socket (2). Yet another difference is that the void (15) in the present power socket (2) does not comprise side walls.

FIG. 8 shows a power socket (2) of type I after installation of the cover plate (3). The power socket (2) is the power socket (2) of FIG. 7. The void (15) is reachable via the ground opening (28) of the cover plate (3).

It is supposed that the present invention is not restricted to any form of realization described previously and that some modifications can be added to the presented example of fabrication without reappraisal of the appended claims.

### LIST OF NUMBERED ITEMS

1 socket assembly
2 power socket
3 cover plate
4 socket body
5 electrical cable
6 wall
7 use side face
8 flange
12 electrical contact opening
13 electrical contact opening
14 ground electrical contact opening
15 void
16 first fastener recess
17 first recess for first snap-fitting hook
18 second recess for second snap-fitting hook
19 third recess for third snap-fitting hook
20 second snap-fitting hook
21 third snap-fitting hook
22 second fastener recess
23 end wall
24 lip
25 first snap-fitting hook
26 electrical contact opening of the cover plate
27 electrical contact opening of the cover plate
28 ground electrical contact opening of the cover plate

1. A power socket assembly comprising:
a power socket comprising use side electrical contacts; and
a cover plate for covering the said power socket, the cover plate having openings to permit access to the electrical contacts of the power socket;
characterized in that the cover plate is press-fit or snap-fit onto said power socket, which power socket comprises a void behind the cover plate, said void is located adjacently to a passage in the power socket leading to an electrical contact and is accessible for a tip of a tool inserted through an opening to the electrical contact adjacent to said void.

2. The power socket assembly according to claim 1, characterized in that, said void is reachable via a ground opening of the power socket.

3. The power socket assembly according to claim 1, characterized in that, said void comprises a wall parallel to the cover plate and configured to shield the void from the electrical contacts, said wall being located at a side of the void opposite to the cover plate.

4. The power socket assembly according to claim 3, characterized in that, said void further comprises a lip extending from said wall towards the cover plate, said lip being located between said void and the adjacent electrical contact.

5. The power socket assembly according to claim 1, characterized in that, the power socket is a type B power socket according to the IEC 60083:2015 standard.

6. The power socket assembly according to claim 1, characterized in that, the power socket is a type G power socket according to the IEC 60083:2015 standard.

7. The power socket assembly according to claim 1, characterized in that, the power socket is a type I power socket according to the AS/NZS 3112:2017 standard.

8. The power socket assembly according to claim 1, characterized in that, the power socket assembly is flush mounted in a surface.

9. The power socket assembly according to claim 8, characterized in that, said cover plate completely covers the use side of the assembly after mounting.

10. The power socket assembly according to claim 1, characterized in that, the cover plate comprises at least two snap-fitting hooks located opposite to each other relative to a center of said cover plate, at least one of said hooks being next to said void.

11. A method for installing and removing a cover plate of a power socket assembly, the method comprising the steps of:
installing a power socket comprising use side electrical contacts onto a surface; and
installing said cover plate comprising opening for accessing said electrical contacts onto said power socket;
characterized in that, the front cover plate is press-fit or snap-fit to the power socket, said power socket comprising a void adjacently extending from a passage in the power socket leading to an electrical contact, said void being located behind the cover plate and being accessible via an opening in the cover plate to the electrical contact adjacent to said void, the cover plate being removed by inserting a tip of a tool into said void and exerting force on the cover plate, said force having a substantially outwards direction towards a use side of the socket assembly.

12. The method according to claim 11, characterized in that, the cover plate is removed by inserting the ground pin of a power plug into said void, and prying the cover plate out.

13. The method according to claim 11, characterized in that, the cover plate is installed by inserting a first snap-fitting hook onto a complimentary recess on the power socket, the first hook being located next to said void and by subsequently inserting at least a second snap-fitting hook located opposite to said first hook.

14. The method according to claim 13, characterized in that, the cover plate is removed by first unhooking said first snap-fitting hook next to said void, and any further hooks afterwards.

15. The method according to claim 11, characterized in that, the cover plate is removed by inserting a hook into said void and by pulling with said hook.

16. A kit for mounting a power socket assembly, the kit comprising:
a power socket having a use side with electrical contacts; and
a cover plate, the cover plate having openings to permit access to said electrical contacts of the power socket;
characterized in that, the cover plate is configured to be press-fit or snap-fit to said power socket, said power socket further comprising a void adjacently extending from a passage in the power socket leading to one of the electrical contacts.
